(19) United States
(12) Patent Application Publication
(10) Pub. No.: US 2008/0058059 A1
(43) Pub. Date: Mar. 6, 2008

(54) Gaming Machine Configuration Methods and Apparatus

(76) Inventors: Matthew R. Fitzsimons, Lake in the Hills, IL (US); Samuel D. Ralston, Chicago, IL (US)

Correspondence Address: SCHWEGMAN, LUNDBERG & WOESSNER, P.A., P.O. BOX 2938, MINNEAPOLIS, MN, 55402, US

(21) Appl. No.: 11/576,065

(22) PCT Filed: Sep. 19, 2005
(86) PCT No.: PCT/US05/33486

§ 371 Date: Mar. 27, 2007

Related U.S. Application Data
(60) Provisional application No. 60/614,336, filed on Sep. 29, 2004.

(51) Int. Cl. A63F 13/00

(52) U.S. Cl. 463/20; 704/243

(57) ABSTRACT

Methods and apparatus for configuring an electronic game system (100, FIG. 1) include executing a configuration tool, which causes a sequence of user prompts to be displayed on a display device, in an embodiment. The sequence of user prompts enables a user to configure a set of configurable items for the gaming machine. Selected ones of the user prompts identify a configurable item and indicate a setting for the configurable item. In an embodiment, items within at least one subset of configurable items have a relationship to each other, and the sequence of the user prompts is at least partially defined by the relationship.

### RELATED APPLICATION

This application claims the priority benefit of U.S. Provisional Application Ser. No. 60/614,336 filed Sep. 29, 2004, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### TECHNICAL FIELD

The inventive subject matter described herein relates generally to electronic games and systems and, more particularly, to methods and apparatus for configuring a gaming machine.

### BACKGROUND

Wagering games have become very popular with casino visitors, and thus are very lucrative for casino operators and game producers. Accordingly, various electronic casino games have been developed, such as electronic slot machines, poker games, and roulette games, to name a few examples.

Prior to a gaming machine becoming active on a casino floor, the machine is configured. Gaming machine configuration typically is performed by a skilled technician who has been granted a special authority to program a machine, and who also possesses a detailed knowledge of the machine's configurable parameters. For example, configurable parameters may include peripheral device identities and communication information, base denominations, wagering limits, and payout percentages, to name a few examples.

A technician who is configuring a gaming machine should be able to physically identify the gaming machine's peripheral devices, and incorporate the devices' information into stored configuration data within the machine. In some cases, peripheral identification is difficult, because not all types of peripherals may be visible to or readily identifiable by the technician. In addition, the technician should have knowledge of the machine's other configurable parameters, and knowledge of how to access the gaming system menus in order to configure those parameters. If various parameters are configured with invalid values or in an improper sequence, the gaming device may be inoperable or may malfunction. As gaming machines become more and more complicated, and the numbers and types of possible peripheral devices continues to increase, the risks also increase of technicians inadvertently mis-configuring gaming machines.

### BRIEF DESCRIPTION OF THE DRAWINGS

FIG. 1 illustrates a simplified block diagram of a gaming machine system, in accordance with an embodiment of the inventive subject matter;

FIG. 2 illustrates a simplified block diagram of a gaming machine, in accordance with an embodiment;

FIG. 3 illustrates a flowchart of a method for initiating a gaming machine configuration tool, in accordance with an embodiment;

FIG. 4 illustrates an example display screen for an administration mode menu, in accordance with an embodiment;

FIG. 5 illustrates a flowchart of a method for executing a gaming machine configuration tool, in accordance with an embodiment; and

FIGS. 6-15 illustrate example display screens associated with a gaming machine configuration tool, in accordance with various embodiments.

### DESCRIPTION OF THE EMBODIMENTS

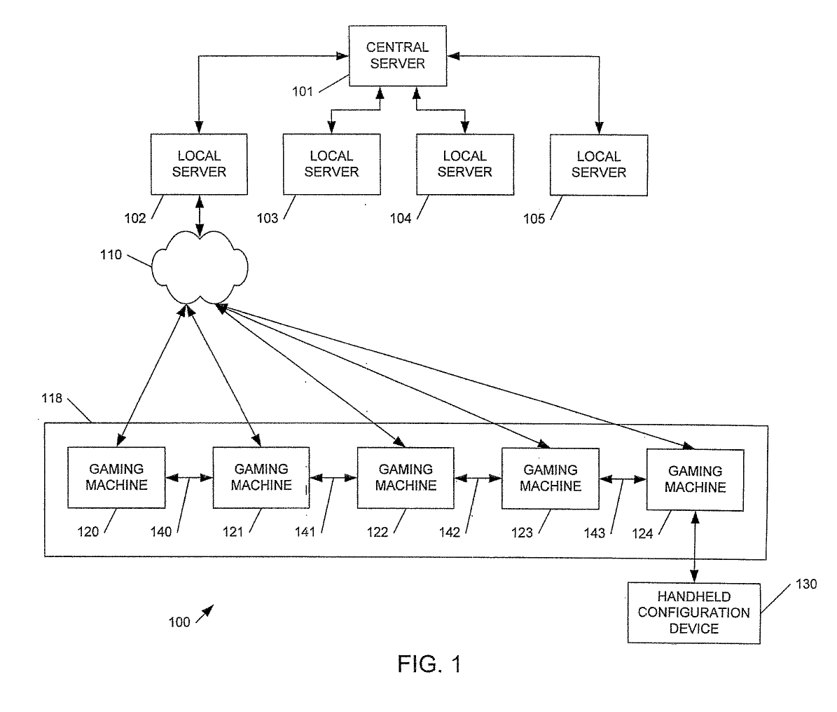

FIG. 1 illustrates a simplified block diagram of a gaming machine system 100, in accordance with an embodiment of the inventive subject matter. System 100 may include at least one central server 101, which communicates with one or more local servers 102, 103, 104, 105 over a public or private network. Central server 101 may be, for example, a server that is associated with a centralized computing facility for a corporation that owns and/or manages multiple casinos at multiple locations.

One or more local servers 102-105 may be resident at a casino location. A local server (e.g., server 102) may communicate over one or more networks 110 to one or more groups or clusters 118 of gaming machines 120, 121, 122, 123, 124. Network 110 may be, for example, but not by way of limitation, a casino area network, a wide area network (WAN), a wide area progressive network, a bonus game network, a cashless system network, a local area network (LAN), or another type of network.

Local server 110 may provide a variety of gaming service to gaming machines 120-124 across network 110. Gaming services provided over a network may include, for example, player tracking services, accounting services, electronic funds transfers to and from a machine, external wins and awards, ticket redemption, lottery services, progressive game services, bonus games, and other gaming services.

A number of proprietary communications networks and protocols have been developed to provide gaming system services. Each network gaming service may be provided utilizing a separate proprietary communication protocol and associated network hardware. Thus, for example, for a gaming machine to support four network gaming services, the gaming machine may need to be capable of supporting four distinct communication protocols and to interface with four different hardware networks.

Because a server 110 may provide a variety of gaming system services, a server may communicate according to a variety of communication protocols and using various types of hardware. Communications may be performed using one or more of a variety of communications protocols, including, but not limited to, SAS (Slot Accounting System), SDS (Slot Data System), BOB (Best of Breed), WAP (Wide Area Progressive), LAP (Local Area Progressive, MICON, or other proprietary or non-proprietary protocols.

In alternate embodiments, one or more servers may provide multiple gaming services over a network using a common protocol. For example, a server may include a network interface that translates messages encoded using one or more proprietary protocols into messages encoded in a common protocol (e.g., TCP-IP, ATM, SLIP, PPP, a layer/protocol transmitted on top of TCP/IP, or some other protocol), which may or may not be proprietary. A gaming machine may have a corresponding network interface, which converts the network-received messages back into the corresponding proprietary protocols.

A group of gaming machines 120-124 may be connected together through peer-to-peer links 140, 141, 142, 143. In various embodiments, links 140-143 may connect machines 120-124 in a daisy-chain fashion, a star topology, a ring topology, a hub topology, or the like. Links between central server 101, local servers 102-105, network (e.g., network 110), and gaming machines 120-124 are for illustration purposes only, and these links may be alternatively arranged, in other embodiments. Further, although one central server, four local servers, and one group of five gaming machines are illustrated in FIG. 1, for simplicity sake, more or fewer servers, groups, and/or gaming machines may be present within a system.

In an embodiment, the gaming machines 120-124 may include electronic wagering gaming machines, such as upright, casino-style, electronic gaming machines. In this type of machine, the player sits or stands in front of the machine, and provides various user inputs as prompted by images that are displayed within a substantially vertical display area. In other embodiments, gaming machines 120-124 may include pub-style, electronic gaming machines. The user also sits or stands in front of this type of machine. However, the display area is viewed through a substantially horizontal surface, such as a transparent counter top surface, for example.

A gaming machine 120-124 may be used to execute one or more electronic games for the entertainment of the user. In various embodiments, these games include, for example, electronic implementations of various wagering games, such as a slot machine, bingo or keno game, craps game, roulette wheel, card game (e.g., video poker and blackjack), game show, racing game, and trivia game. In other embodiments, other wagering or non-wagering games are executable in conjunction with the gaming machine 200 (e.g., search and destroy games, course navigation games, and numerous other types of games).

In an embodiment, each gaming machine 120-124 may be subjected to an initial configuration process prior to it being ready for game play. An initial configuration process includes defining settings for a number of configurable items. These settings may include binary, text, numeric, or other types of data values, which are stored in the machine, and which may be used by the machine during game play, during idle times, during communication with a server 102-105, during communication with another machine, during interaction with peripheral devices, and at other times.

Configurable items are entities that may be relevant to machine setup, the type of game or games that are playable on the machine, communications protocols, and other items related to a gaming machine's operation. For example, but not by way of limitation, configurable items for a particular gaming machine may include any one or more items selected from a group of items that includes a peripheral device parameter, a time, a date, a base denomination, a limit, a percentage, a game configuration parameter, a communications protocol, a progressive play parameter, a display feature, and an output volume, to name a few. More, fewer or different configurable items may be associated with a particular gaming machine, in other embodiments.

After an initial configuration process has been performed, one or more configurable items may be re-configured at a later time. For example, but not by way of limitation, a gaming machine may be reconfigured from a nickel machine to a quarter machine, or the communications protocol between the gaming machine and the server may be changed. Whether an initial configuration process is being performed or a re-configuration process is being performed, various embodiments of the inventive subject matter may enable a gaming machine to be relatively easily and accurately configured.

In an embodiment, an initial or re-configuration process is performed at a gaming machine (e.g., machine 124). An authorized person may begin the process by unlocking the gaming machine cabinet, and initiating a startup event (e.g., pressing an “administration” button located within the cabinet or detecting some other electrical signal from a user interface). In an embodiment, this may initiate execution of a configuration tool (i.e., a software program for configuring a machine), which causes a sequence of configuration-related, user prompts to be presented to the user. Through interaction with a user interface (e.g., a display touch-screen), the person may then configure or re-configure the machine.

In an alternate embodiment, the person may connect a handheld configuration device 130 to the gaming machine 124 (e.g., through a serial port or other type of connection), and may interact with a configuration tool through a user interface associated with the device 130. In a further embodiment, the handheld configuration device 130 may store information that enables it to duplicate a previously-performed configuration on one or more additional machines. For example, but not by way of limitation, device 130 may store a macro, which may duplicate the configuration setting selections associated with a previous execution of the configuration tool. The person performing the duplicate configuration may be given the options of exactly duplicating the previously-performed configuration process, of modifying the previously-performed configuration process, or of performing a new configuration process without reference to a previously-performed process. In still another embodiment, gaming machine configuration could be performed remotely by a user at a server (e.g., server 102) over a networked connection to a gaming machine (e.g., machines 120-124).

For ease of explanation, the description below explains embodiments where a person configures a gaming machine through direct interaction with the gaming machine itself. For example, but not by way of limitation, the person may view, input and/or modify configuration settings using a touch-screen associated with the gaming machine. It is to be understood that, in other embodiments, configuration settings may be viewed, entered or modified using other types of user interfaces, and/or through indirect communication with the gaming machine (e.g., communication over a wired or wireless link).

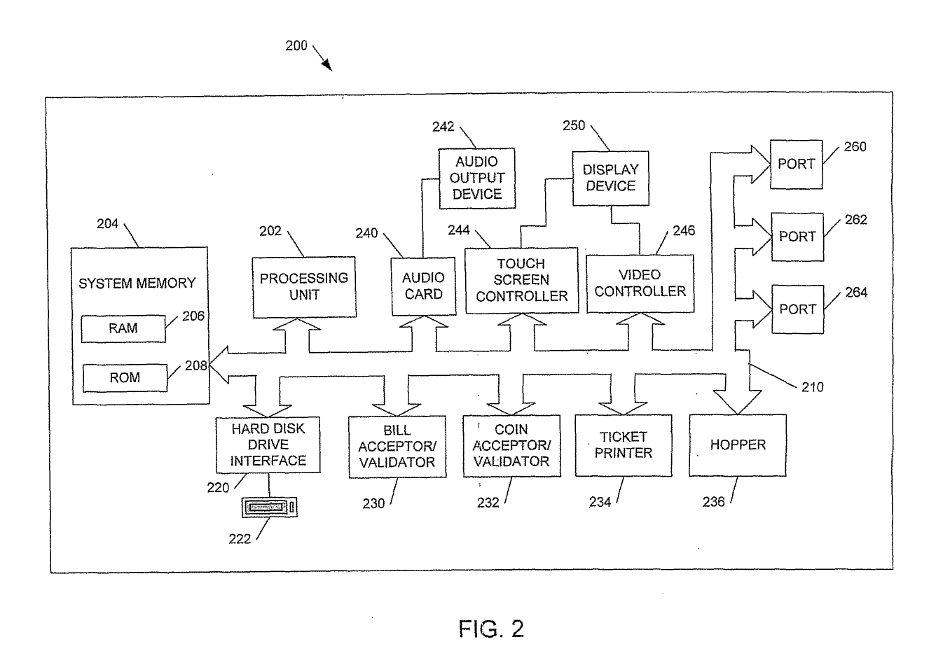

FIG. 2 illustrates a simplified, functional block diagram of a gaming machine 200, in accordance with an embodiment. Gaming machine 200 includes a processing unit 202 and a system memory 204, in an embodiment. The term “processing unit” is not meant to restrict the processing element to a single device. Instead, in various embodiments, the processing unit 202 includes one or more general-purpose or special purpose microprocessors, one or more application specific integrated circuits (ASICs), and/or one or more other integrated or separate processing elements.

Processing unit 202 stores and retrieves information from system memory 204, which is one of potentially several elements for storing information, in an embodiment. The term “information” is meant to include machine readable instructions and/or permanent or temporary data. For example, machine readable instructions may be instructions relating to a configuration tool or to a game, among other things. Further, data may include configuration settings for the machine.

During game play, processing unit 202 executes a series of the machine readable instructions, in an embodiment, which cause the game to progress through various states and iterations, and which cause various images to be displayed on the display device 250. In addition, in an embodiment, during a configuration process, processing unit 202 executes a series of machine readable instructions associated with a configuration tool, as will be explained in more detail later.

Processing unit 202 can communicate with system memory 204 and with other components of the gaming device over one or more physical links 210 which employ one or more communications protocols. Communications protocols supported on the physical link(s) may include, for example RS-422/485, RS-232, Fiber Optic, FireWire, Ethernet, Universal Serial Bus (USB) and/or other proprietary or non-proprietary protocols. In an alternate embodiment a separate link and/or memory controller (not shown) may exist between processing unit 202 and system memory 204.

In an embodiment, system memory 204 includes random access memory (RAM) 206 and read only memory (ROM) 208. Machine readable instructions for performing the methods of various embodiments are stored in ROM 208 and/or RAM 206, in an embodiment. In addition, various permanent and/or run-time data are stored in ROM 208 and/or RAM 206, in an embodiment. For example, ROM 208 and/or RAM 206 may include a configuration database, which includes data describing current settings for a set of configurable items.

Another element for storing information included in the machine 200, in an embodiment, is a hard disk drive 222, which is capable of reading from and writing to a hard disk (not shown). The hard disk drive 222, is connected to the system bus 210, and thus to processor 202, by a hard disk drive interface 220. In other embodiments, where software and/or other information is stored on removable media, an element for storing information includes a magnetic disk drive (not shown) for reading from or writing to a removable magnetic disk, and/or an optical disk drive (not shown) for reading from or writing to a removable optical disk, such as a CD ROM or other optical media.

As is discussed in more detail later, the inventive subject matter described herein can be implemented in a wagering game machine. Accordingly, in an embodiment, the machine 200 also may include one or more peripheral devices for accepting and dispensing money and/or credits. For example, but not by way of limitation, machine 200 may include any combination of a bill acceptor/validator 230, a coin acceptor/validator 232, a ticket printer 234, and a coin hopper 236. In other embodiments, other devices also or alternatively may be included for accepting payment, such as readers or validators for credit cards, debit cards, and/or smart cards. Other types of insertable cards are also or alternatively used, in an embodiment, including casino-issued debit cards that store information regarding a variable quantity of credits or money available to the player. Other peripheral devices also may be connected to or installed on a machine.

In various embodiments, peripheral devices (e.g., devices 230, 232, 234, 236) may communicate with processing unit 202 over physical link 210, or they may be communicate with processing unit 202 through various ports, such as one or more serial ports, USB ports, parallel ports, game ports, combinations of these types of ports or other types of ports. Accordingly, each device may communicate with processing unit 202 through an interface and/or physical connection that is different from that illustrated in FIG. 2.

Gaming machine 200 may operate in a stand-alone manner, or may communicate with one or more other computers (e.g., server 102, FIG. 1). Accordingly, machine 200 may include from one to many ports 260, 262, 264. Although three ports 260, 262, 264 are illustrated, machine 200 may include more or fewer ports. As will be described in more detail later, each of these ports 260, 262, 264 may be configured to communicate using a particular protocol (e.g., SAS, SDS, BOB, WAP, LAP, MICON, etc.).

Prior to enabling the machine 200 for play, the machine undergoes a configuration process, as described above. As will be explained in more detail later, a configuration tool may be used to establish or affirm settings for a set of configurable items, in an embodiment. Once configured, and when a player has entered money, in one form or another, the machine 200 allows the player to play one or more iterations of a game. During play, the player manipulates various user interfaces for receiving input from the player. These mechanisms may include, for example, a touch-screen, button panel, and/or a mechanical slot-machine lever arm, to name a few.

Visual feedback is provided to the player via a display device 250. Further, audio feedback may be provided using one or more audio output devices 242, in an embodiment. Display device 250 and audio output device 242 may communicate with processing unit 202 via a video controller 246 and an audio card 240, respectively. In addition, in an embodiment that uses touch-screen technology, a touch-screen display device 250 interacts with processing unit 202 via a touch screen controller 244. Besides gaming-related images, as will be described in more detail later, the display device 250 also may be used to display images related to a configuration tool, and to receive configuration-related inputs (e.g., via a touch-screen) from a person configuring the machine 200. In other embodiments, the machine 200 also or alternatively may include a microphone, which interacts with speech recognition software, a mouse, a button board, a keyboard, a game controller (e.g., with toggle switches, direction buttons, etc.), and various other types of input devices.

The machine 200 described in conjunction with FIG. 2 is particular to a game machine that provides a player with entertainment in exchange for money or credit. The illustrated system is a stand-alone system, in an embodiment, which may include all necessary hardware and software for executing the game. In other embodiments, certain features described in conjunction with the machine 200 of FIG. 2 may be excluded. For example, a system that does not accept or pay out money may not include bill acceptor/validator 230, coin acceptor/validator 232, ticket printer 234 and/or hopper 236, in various embodiments.

In a typical wagering game, a number of configurable items may define the game itself. For example, but not by way of limitation, game-related configurable items may include base denominations, credit limits, percentages, and progressive play settings, among other things. Other aspects of the machine also may be configured. For example, the time and date, volume, sounds, visual outputs (e.g., lights), communication protocols, peripheral device setups, and other features may be configured. Embodiments of the inventive subject matter include methods for configuring a gaming machine.

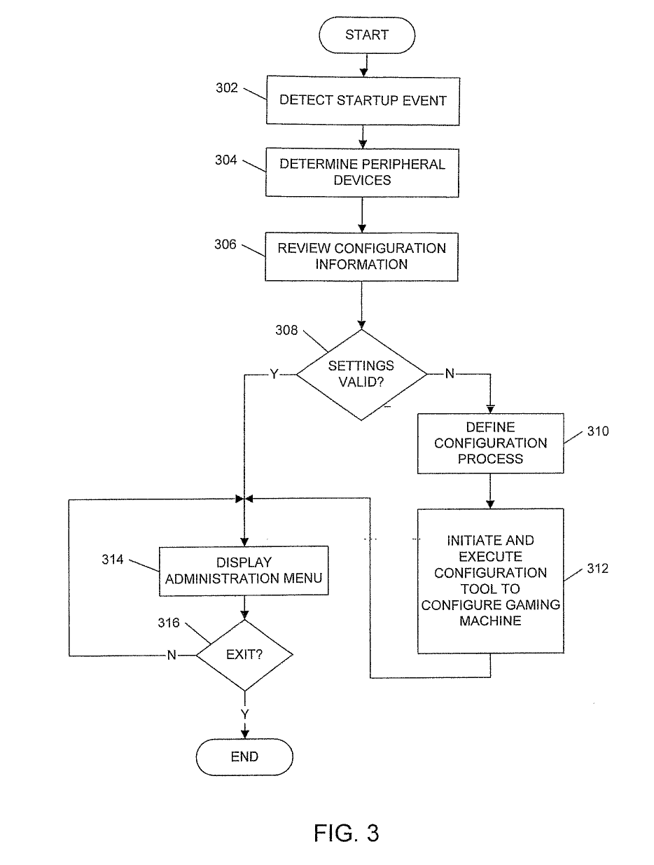

FIG. 3 illustrates a flowchart of a method for initiating a gaming machine configuration tool, in accordance with an embodiment. Substantially all of the method may be implemented on the gaming machine being configured, in an embodiment. In alternate embodiments, portions of the method may be implemented on a remote device (e.g., configuration device 130 or server 102, FIG. 1) in conjunction with the gaming machine being configured.

The method begins, in block 302, when a configuration startup event is detected. A configuration startup event may be, for example, a person pressing an administration button within the cabinet of the gaming machine. Alternatively, a configuration startup event may be receipt of a user input (e.g., via a touch on a touch-screen or a mouse click) indicating that the user desires to initiate the configuration tool. In another embodiment, a configuration startup event may be detection of a first boot up of the gaming machine. Other configuration startup events also or alternatively may trigger initiation of the configuration tool.

When a configuration startup event has been detected, then the gaming machine is analyzed, in an embodiment. Analysis of the gaming machine includes determining which peripheral devices are installed on the machine (or in a top box), in block 304, in an embodiment. One or more installed peripheral devices (e.g., devices 230, 232, 234, 236, FIG. 2) may be automatically detected, in an embodiment, over one or more links (e.g., link 210, FIG. 2).

In an embodiment, gaming machine analysis further includes reviewing stored configuration information, in block 306. Configuration information is stored within a configuration database in the machine's system memory (e.g., memory 204, FIG. 2) in an embodiment. When a setting is stored into the configuration database, it is considered to be “committed,” and thus a part of the “current configuration.” A setting that is merely displayed on the display screen, but which has not yet been stored into the configuration database is not considered to be committed, and thus that setting may not yet a part of the current configuration. A setting is considered to be a “user-affirmed” setting when an action has occurred, which indicates that the user may desire the setting ultimately to be committed to the configuration database. A “user-affirmed” setting may or may not be a committed setting. The term “user-affirmed” will be explained in more detail later.

A determination is made, in block 308, whether settings for all “primary configurable items” are valid. “Primary configurable items” are defined herein as configurable items that should have a non-null setting in order for the machine to function properly during game play and also at other times. For example, primary configurable items may include peripheral device settings, base denominations, credit limits, payout percentages, and communications protocols, among other things. Other configurable items may be considered to be “secondary configurable items,” meaning that the items do not necessarily have to have a non-null or valid setting in order for the machine to function properly during game play. For example, a secondary configurable item may be the speaker volume. Whether a configurable item is a primary or secondary configurable item is a matter of design choice.

A setting may be considered “valid” if it has a non-null value. Further, settings for some configurable items may only be considered valid if they fall within certain allowable ranges or have one or more of a limited set of values.

If one or more settings for the primary configurable items are not valid, as determined in block 308, then a configuration process is defined, in block 310, in an embodiment. Defining the configuration process may include, for example, identifying configurable items that should be set and/or affirmed by a user, and determining a sequence for causing user prompts to be displayed for the identified configurable items.

In an embodiment, the configuration process may be defined so that it excludes display of user prompts relating to one or more configurable items that have valid values stored for them in the configuration database. Further, the configuration process may be defined so that it includes user prompts relating to installed peripheral devices that were detected. User prompts relating to peripheral devices that were not detected may be excluded, in an embodiment. Still further, in an embodiment, the configuration process may be defined to take into account any order-dependencies that may be beneficial to follow in setting values for related configurable items. For example, if it is better to set a value for a first configurable item prior to setting a value for a second configurable item, the configuration process may be defined to display a user prompt for the first configurable item earlier in the configuration process sequence than it displays a user prompt for the second configurable items. Other considerations may be taken into account in defining the configuration process' contents and/or sequence, in other embodiments.

In still another embodiment, the set of configurable items and the sequence for presenting associated user prompts for a given configuration process may not vary based on detected peripheral devices and/or review of the current configuration data. In such an embodiment, the configuration process may simply present a sequence of user prompts to the user in the same way each time the configuration process is executed. In such embodiments, some or all of blocks 304, 306, 308, and 310 may be excluded.

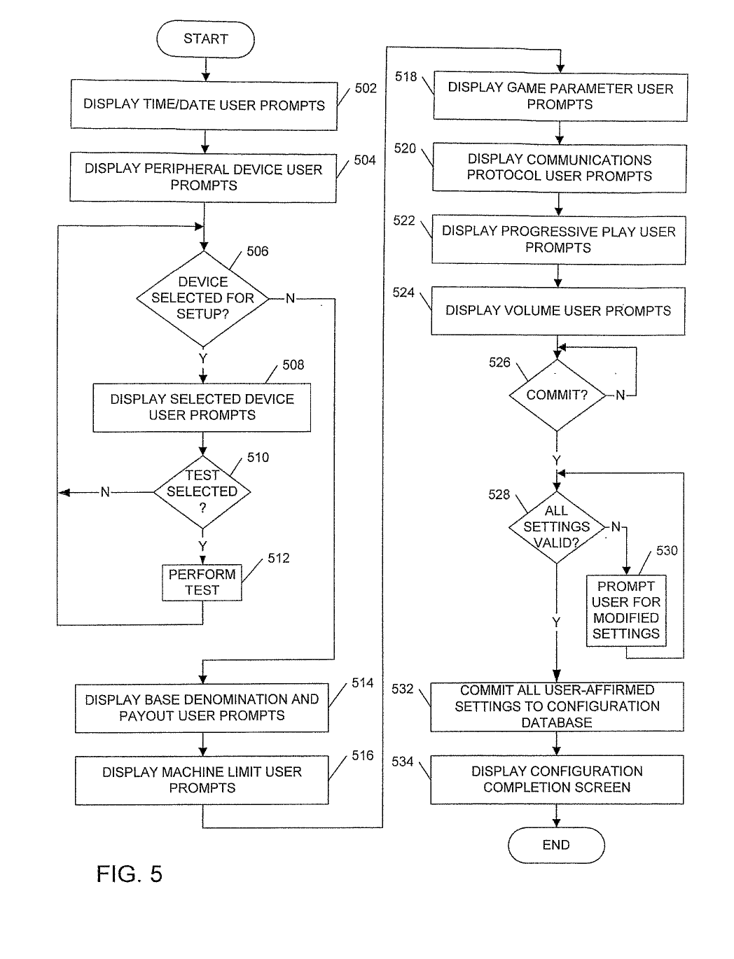

The configuration tool is initiated and executed, in block 312, in an embodiment. Executing the configuration tool includes causing a sequence of user prompts to be displayed on a display device to enable a user to configure a set of configurable items for the gaming machine. In an embodiment, selected ones of the user prompts identify a configurable item and indicate a setting for the configurable item. In a further embodiment, at least one subset of configurable items have a relationship to each other, and the sequence of the user prompts is at least partially defined by the relationship. Details of the configuration tool execution are explained later, in conjunction with FIGS. 5-18.

When the configuration execution process of block 312 has completed, or if it is determined in block 308 that the configuration information is complete and valid, then an “administration mode” menu may be displayed, in block 314.

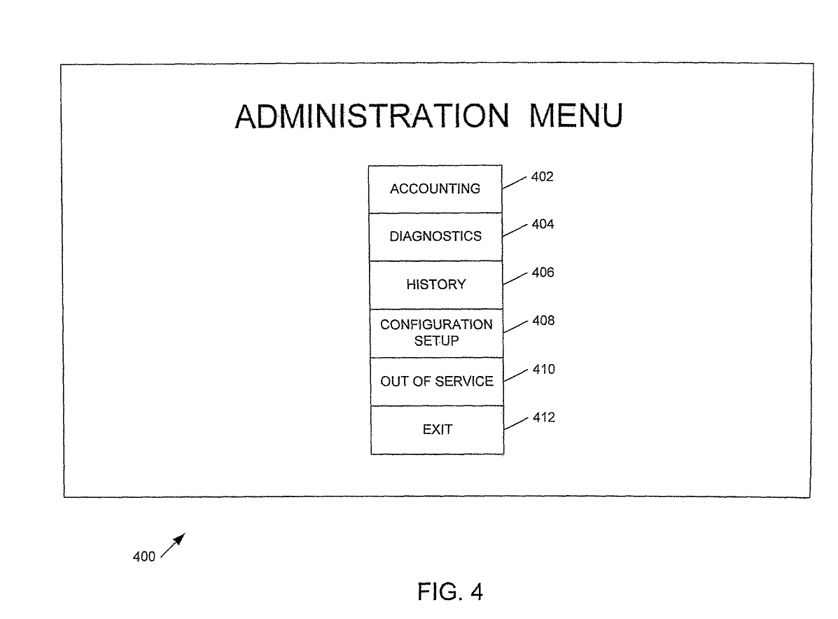

The administration mode menu enables the user to perform other administration-related tasks (e.g., review machine diagnostics, check play history, etc.). FIG. 4 illustrates an example display screen for an administration mode menu 400, in accordance with an embodiment. Menu 400 may be displayed, for example, on a gaming machine's display device (e.g., device 250, FIG. 2).

Menu 400 may include multiple screen elements 402, 404, 406, 408, 410, 412, at least some of which are selectable by a user. For example, for a touch-screen display device, a user may select an element by pressing his or her finger on an area of the touch-screen proximate to the element the user desires to select. In other embodiments, an element may be selected using a mouse click, by toggling through the elements using arrow keys, or by some other method. For the purposes of brevity, and for each of the subsequently-described figures, the description herein refers to selection of elements and setting of values using a touch-screen. It would be apparent to one of skill in the art that other user interfaces may be employed to select screen elements and/or to set values.

In the example administration mode menu 400, selectable elements include an accounting element 402, a diagnostics element 404, a history element 406, a configuration setup element 408, an out of service element 410, and an exit element 412. Selection of elements 402, 404, and 406 may cause the machine to display information regarding accounting, diagnostics, and play history, respectively. These aspects of the administration mode are outside the scope of the present inventive subject matter, and therefore are not discussed in detail herein. Selection of element 410 may enable the user to place the machine “in service” or “out of service.” When the machine is placed “out of service,” it is disabled for game play. When the machine is placed “in service,” it is enabled for game play.

Selection of “configuration setup” element 408 results in initiation of a configuration tool, in accordance with an embodiment. Selection of element 408 may be one of several ways of initiating the configuration tool. In another embodiment, the configuration tool may automatically be initiated when, for example, the machine is booted up for the first time. Alternatively, if a boot up occurs, and a determination is made that the configuration information stored for the machine is not complete and/or valid, then the configuration tool may be initiated. These scenarios were described in more detail earlier.

A user may exit the administration mode by selecting element 412. Referring back to FIG. 3, when it is determined that the user wishes to exit, in block 316 (e.g., by selecting element 412, FIG. 4), then the process ends.

A configuration tool in accordance with various embodiments will now be described in more detail in conjunction with FIGS. 5-18. FIG. 5 illustrates a flowchart of a method for executing a gaming machine configuration tool (e.g., block 312, FIG. 3), in accordance with an embodiment. In an embodiment, some or all of the processes described in conjunction with FIG. 5 are performed by a processing unit (e.g., processing unit 202, FIG. 2) associated with a gaming machine. In alternate embodiments, some or all of the processes may be performed by other processing components and/or electrical systems.

As the flowchart of FIG. 5 will make clear, a configuration tool of the various embodiments guides a user through a configuration process. Further, where a set of configurable items should be configured by the user in an order-dependent manner, a configuration tool of an embodiment causes user prompts to be displayed for the configurable items according to the order dependency. Further, in an embodiment, a configuration tool provides user prompts for peripheral devices that have been determined to be connected to or resident within the machine. Accordingly, embodiments of the inventive subject matter may enable a user to configure a gaming machine more quickly and accurately than is possible using traditional gaming machine configuration methods.

In an embodiment, executing the configuration tool causes a sequence of user prompts to be displayed on a display device, where a user prompt may identify a configurable item associated with the gaming machine. Further, a user prompt may indicate a setting for the configurable item. The setting for the configurable item may be modifiable by a user through a user interface (e.g., interaction with a touch-screen).

Throughout the description, when reference is made to a user “selecting” a setting, it is to be understood that this selection may be made through one or more of a variety of user interfaces (e.g., touch-screen, keyboard, voice recognizer, mouse, arrow keys, etc.), and using a variety of different types of screen elements for enabling a user to select or modify a value (e.g., through text entry, drop-down menus, scrolling, selecting a value from a list, etc.). Although specific examples are illustrated and described, below, these examples are not meant to be limiting. Further, although specific user prompts are shown as being included on specific display screens, it is to be understood that each user prompt is not limited to be included strictly as shown on the example display screens. In other embodiments, some user prompts may be displayed alone on a display screen, and/or other combinations of user prompts than those illustrated may appear on a particular display screen.

The time, date, and time zone may be considered configurable items for a gaming machine. Thus, referring to FIG. 5, the configuration method may begin, in block 502, by causing one or more user prompts to be displayed on the display device, which include elements that enable the user to set the time, date, and/or time zone.

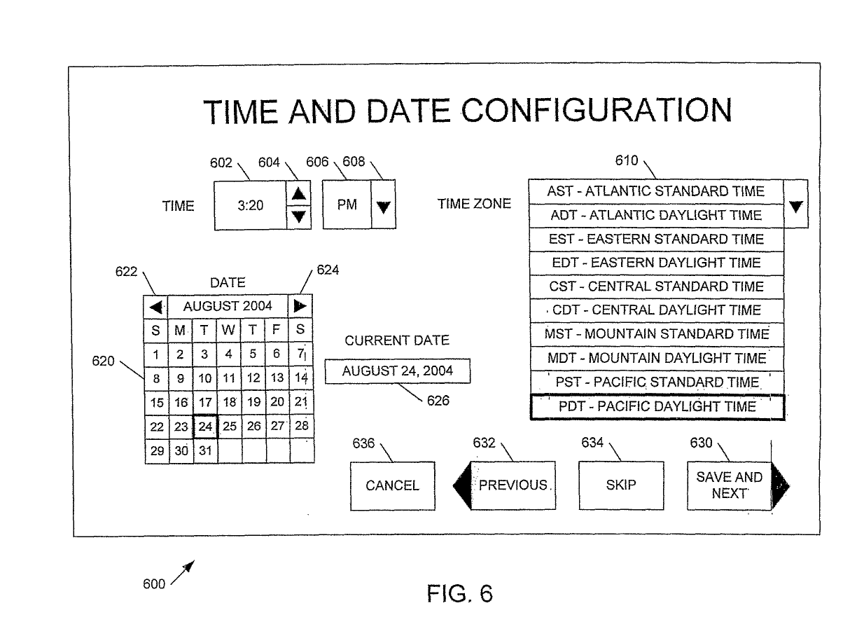

FIG. 6 illustrates an example of a display screen 600 having user prompts relating to setting the time, date, and time zone. A time user prompt enables the user to specify a current time setting 602. In an embodiment, the user may increase or decrease the time setting 602 using up/down arrows 604, and the user may select between an “a.m.” or “p.m.” setting 606 also using an arrow element 608. In an embodiment, the time zone also may be selected (e.g., from a drop-down menu 610 or in some other way) through a time zone user prompt.

The date may be selected, in an embodiment, via a displayed calendar 620 user prompt. In an embodiment, the displayed month may be increased or decreased using arrows 622, 624. When the user has reached a desired month, the user may select a specific date from the calendar. For example, as illustrated, the user has selected Aug. 24, 2004, which may then be displayed as the date setting 626.

When the user is satisfied with the time, time zone, and date settings, the user may select the “save and next” element 630. Alternatively, the user may select the “skip” element 634, if the user wants to proceed through the configuration process, but not to save or affirm information that may be displayed in conjunction with the displayed screen. If, at any time, the user wishes to go back to a previous display screen, the user may select the “previous” element 632, if it is displayed in conjunction with a screen. Finally, if the user wishes to quit the configuration process without saving any information displayed or entered during the process (e.g., “user-affirmed” but not “committed” settings), then the user may select the “cancel” element 636, which may exit the user out of the process. Selection of the “cancel” element 636 may result in the process making no changes to the then-current configuration, and/or leaving the machine in an unconfigured state. When the user selects the “save and next” element 630, the time, time zone, and date settings displayed in elements 602, 606, 610, and 626 are then considered to be “user-affirmed” settings.

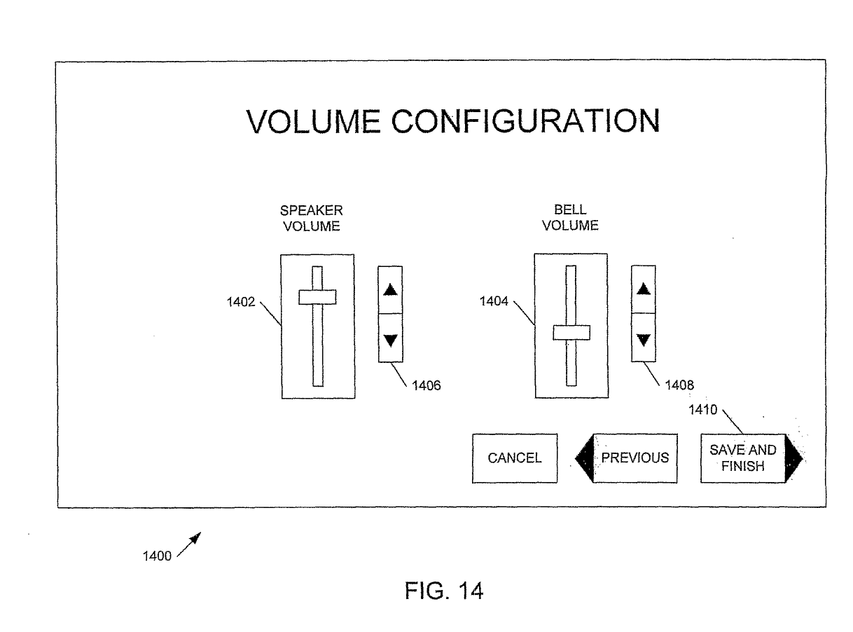

In an embodiment, a “user-affirmed” setting is stored in a temporary storage space. Further, in an embodiment, all “user-affirmed” settings that accumulate during the configuration process are not committed to the configuration database until the user has provided an indication that the user-affirmed settings should be committed. For example, near the end of the configuration process, a display element may give the user the ability to “save and finish” (see, e.g., element 1410, FIG. 14), in an embodiment. If the user selects the “save and finish” element, the user-affirmed settings that have been temporarily stored while proceeding through the configuration sequence may then be committed (i.e., stored) to the configuration database, thus modifying previously stored configuration values that differ from the user-affirmed values. In an alternate embodiment, subsets of the user-affirmed settings from one display screen may be committed to the configuration database each time the user proceeds to a next display screen.

Referring again to FIG. 6, after selecting the “save and next” element 630, the process may cause another display screen to be displayed, which includes subsequent user prompts in the configuration sequence. Settings related to installed peripheral devices may be considered configurable items for a gaming machine. Thus, for example, one or more other display screens may relate to installed peripheral devices.

Referring again to FIG. 5, the method may cause one or more user prompts relating to peripheral device settings to be displayed on the display device, in block 504. In an embodiment, a peripheral device user prompt may include an identity of a peripheral device (e.g., from block 304, FIG. 3) installed on the machine. Further a peripheral device user prompt may include one or more elements indicating whether the device was detected, and one or more elements, which enable the user to set the device in an “enabled state” or a “disabled state.”

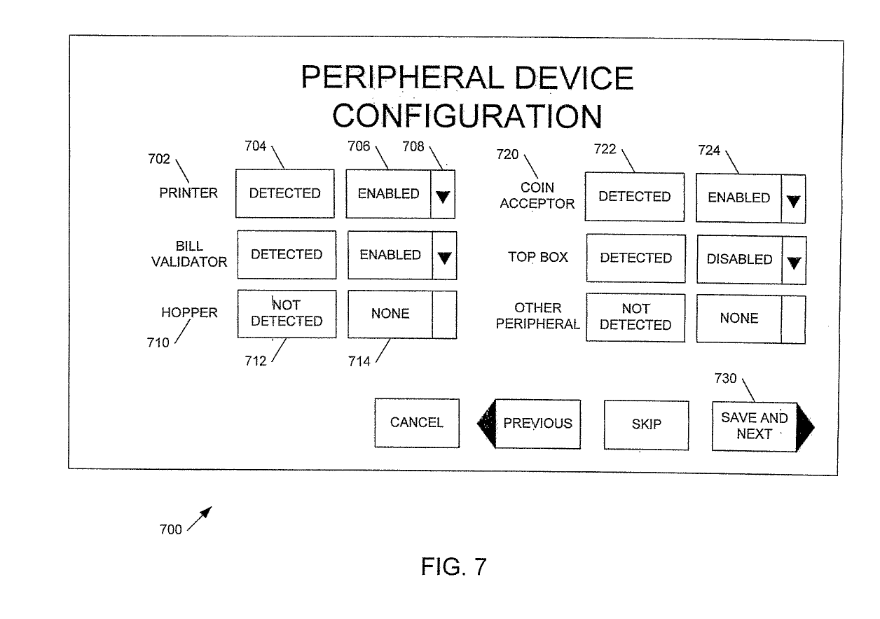

FIG. 7 illustrates an example of a display screen 700 having user prompts relating to setting the state of a set of peripheral devices. In an embodiment, each device of a set of potentially installed peripheral devices may be identified in a name field 702, and an indicator 704 of whether the device was detected or not (e.g., in block 304, FIG. 3) may be included in proximity to the name field 702. An enabled/disabled user prompt 706 may also be included, which enables the user to specify whether the device is to be in an enabled state or a disabled state. In an embodiment, the user may modify the enabled/disabled setting 706 using an arrow element 708.

The example display screen 700 indicates that a printer 702 was detected 704, and that the setting will be saved as enabled 706, if the setting is committed. Further, a hopper 710 was not detected 712. Accordingly, no enabled/disabled setting 714 may be displayed, in an embodiment. Alternatively, the setting 714 may indicate “disabled,” without the option to enable the device, in another embodiment. Further still, a coin acceptor 720 was detected 722, and the setting will be saved as disabled 724, if the setting is committed.

In an embodiment, for each detected device, a user may be able to further configure the device. Referring back to FIG. 5, in block 506, a determination may be made whether a user has selected an installed peripheral device for setup. If so, then the method causes one or more user prompts to be displayed, in block 508, which are relevant to setting up the selected device.

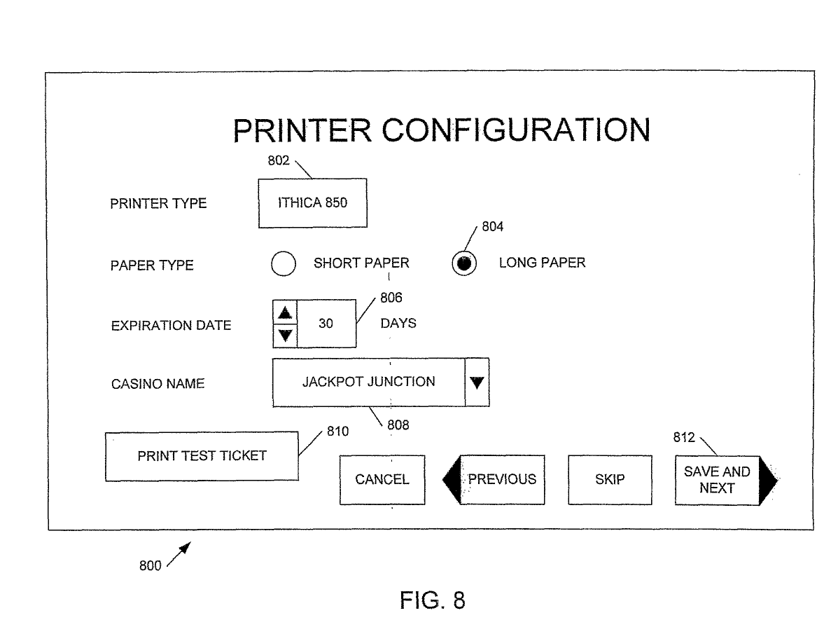

For example, referring again to FIG. 7, a user may be able to select the printer identifier 702, which may cause a printer configuration screen to be displayed, in an embodiment. FIG. 8 illustrates an example of a display screen 800 having user prompts relating to setting a printer device. In an embodiment, a printer identifier field 802 may identify the make and model of the installed printer (e.g., “Ithica 850”). A paper type user prompt may enable the user to specify a setting 804 indicating which type of paper is to be used (e.g., “short paper” or “long paper”). An expiration date user prompt may enable the user to specify a setting 806 indicating when each printed ticket will expire. For example, each time a ticket is printed, the machine may print the then-current date and a statement such as “This ticket will expire in 30 days.” Alternatively, the machine may calculate the expiration date, based on the then-current date and the expiration date setting 806, and print “This ticket will expire on [the calculated date].” A casino name user prompt may enable the user to specify a setting 808 indicating the casino name to be printed on the ticket.

In an embodiment, a user may be given the opportunity to test the functionality of an installed peripheral or other device via the configuration tool. Referring back to FIG. 5, a determination is made whether the user has selected to test a device being configured, in block 510. In an embodiment, a test may be performed by the user selecting a test element (e.g., “print test ticket” 810, FIG. 8). If a test is selected, then the method performs the test, in block 512. For example, if a printer test is selected, the method may cause the printer to print out a test ticket, according to the specified configuration information for the device. According to the example in FIG. 8, a test ticket may be printed on long paper, and on the ticket may be printed “Jackpot Junction” and “This ticket will expire in 30 days.”

Other types of tests may be performed for other types of peripherals. For example, but not by way of limitation, a hopper may be tested by ejecting coins, or a bill acceptor/validator may be tested by allowing the user to insert a bill. Performing a test may alternatively include performing a test selected from a group of tests that includes detecting a touch screen input, validating a coin inserted into a coin validator peripheral device, sending a ping data message over a network, testing a serial communications port, and providing an output signal to an audio output device, detecting a door open state and a door closed state, detecting a switch state change, and turning a lamp on and off. Other tests of other types of peripheral devices may similarly be performed.

When the user is satisfied with the peripheral device settings, the user may select the “save and next” element 812. When the user selects the “save and next” element 812, the device settings displayed in elements 804, 806, and 808 are then considered to be user-affirmed settings, in an embodiment. In addition, after selecting the “save and next” element 812, the process may return to the peripheral device display screen (e.g., screen 700, FIG. 7), thus enabling the user to configure and/or test another device, if desired.

If no further device is selected for setup (e.g., in block 506, FIG. 5), the method may cause another display screen to be displayed, which includes subsequent user prompts in the configuration sequence. A user may indicate that no device (or no further device) is selected for setup, for example, by selecting the “save and next” element 730 (FIG. 7) from the peripheral device display screen 700. When the user selects the “save and next” element 730, the device settings displayed in enabled/disabled elements 706, 724, etc., are then considered to be user-affirmed settings, in an embodiment.

One or more other display screens may relate to base denomination and payout percentage settings. Thus, referring again to FIG. 5, in block 514, the method may cause one or more user prompts to be displayed on the display device, which include elements that enable the user to set one or more base denominations and payout percentages.

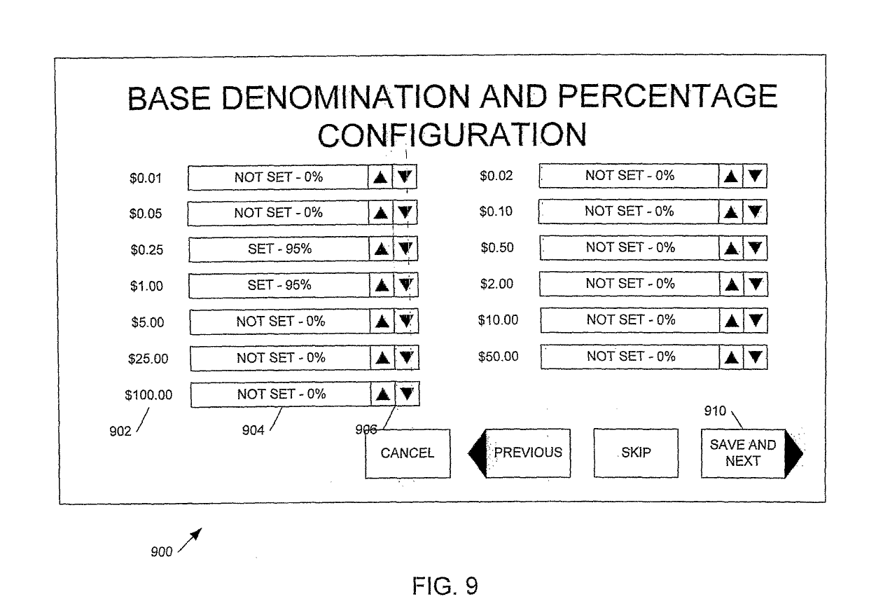

FIG. 9 illustrates an example of a display screen 900 having user prompts relating to setting one or more base denominations and payout percentages. Although base denominations and payout percentages may be set together using the example screen 900, in other embodiments, the base denomination and the payout percentage settings may be established via separate display screens.

In an embodiment, for each of multiple potential base denominations, a denomination amount may be identified in a denomination amount field 902. An indicator 904 of whether the denomination is set may be included in proximity to the denomination amount field 902. In an embodiment, the indicator may specify “set” or “not set.” In another embodiment, if a denomination is not set, a percentage of “0%” or the like may be displayed, and if a denomination is set, a non-zero percentage may be displayed.

In an embodiment, indicator 904 may be a user prompt, which enables the user to specify a payout percentage for each denomination that is set. In an embodiment, the user may modify the payout percentage setting 904 using an arrow element 906. In a further embodiment, the values that may be set within setting 904 may be limited to allowable payout percentages. For example, if the payout percentages for the “$0.25” denomination are restricted to fall within 15%-95%, then the method may only enable the user to cause a value within that range to be set within setting 904.

The example display screen 900 indicates that base denominations “$0.25” and “$1.00” are both set at “95%”, and those setting will be saved if the settings are committed. When the user is satisfied with the base denomination and percentage settings, the user may select the “save and next” element 910. When the user selects the “save and next” element 910, the base denomination and percentage settings displayed in elements 904 are then considered to be user-affirmed settings, in an embodiment.

One or more other display screens may relate to machine limit settings. Thus, referring again to FIG. 5, in block 516, the method may cause one or more user prompts to be displayed on the display device, which include elements that enable the user to set one or more machine limits.

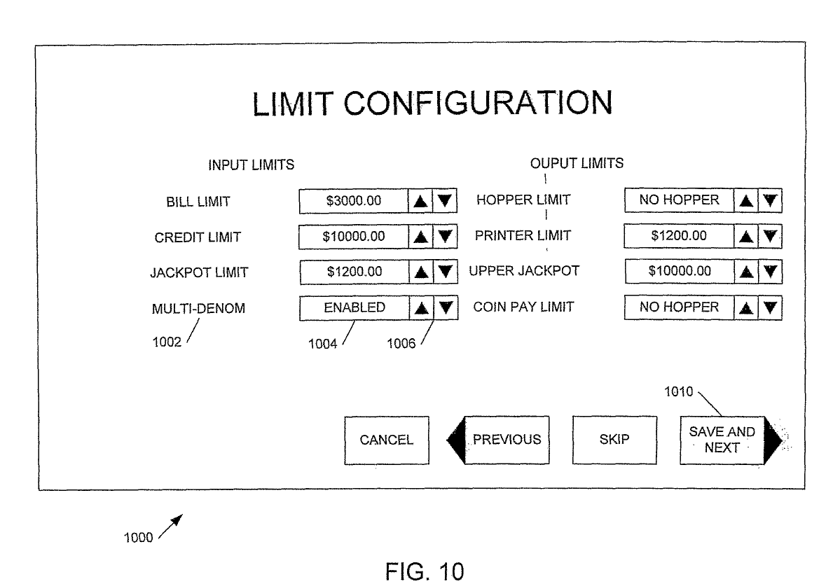

FIG. 10 illustrates an example of a display screen 1000 having user prompts relating to setting one or more machine limits. In an embodiment, a limit type may be identified in a limit type field 1002, and an indicator 1004 of the limit value may be included in proximity to the limit type field 1002. In an embodiment, if a limit is not applicable to the machine, then it may be so indicated. For example, if a hopper is not present, a hopper limit is not applicable, and so an indicator such as “No Hopper” may be displayed in field 1004. In an embodiment, indicator 1004 may be a user prompt, which enables the user to specify a limit value for each applicable limit type. In an embodiment, the user may modify the limit value setting 1004 using an arrow element 1006.

The example display screen 1000 indicates that the “bill limit” is “$3000,” the “credit limit” is “$10000,” etc. Those setting will be saved if the settings are committed. When the user is satisfied with the machine limit settings, the user may select the “save and next” element 1010. When the user selects the “save and next” element 1010, the machine limit settings displayed in elements 1010 are then considered to be user-affirmed settings, in an embodiment.

One or more other display screens may relate to game parameter settings. Thus, referring again to FIG. 5, in block 518, the method may cause one or more user prompts to be displayed on the display device, which include elements that enable the user to set one or more game parameter settings.

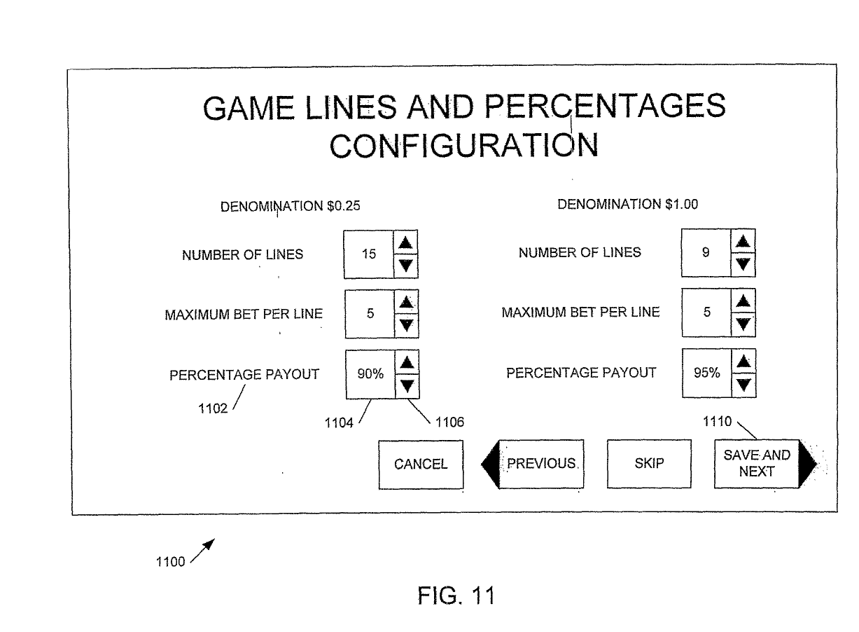

FIG. 11 illustrates an example of a display screen 1100 having user prompts relating to setting one or more game parameter settings. In an embodiment, a game parameter type may be identified in a parameter type field 1102. An indicator 1104 of the parameter value may be included in proximity to the parameter type field 1102. In an embodiment, indicator 1104 may be a user prompt, which enables the user to specify a value for each parameter type. In an embodiment, the user may modify the parameter value setting 1104 using an arrow element 1106.

The example display screen 1100 indicates that, for denomination “$0.25”, the “number of lines” is 15, the “maximum bet per line” is 5, and the “percentage payout” is 90%. Other settings are specified for denomination “$1.00,” which is also set. The displayed setting will be saved if the settings are committed. When the user is satisfied with the game configuration settings, the user may select the “save and next” element 1110. When the user selects the “save and next” element 1110, the game configuration settings displayed in elements 1110 are then considered to be user-affirmed settings, in an embodiment.

One or more other display screens may relate to communications parameter settings. Thus, referring again to FIG. 5, in block 520, the method may cause one or more user prompts to be displayed on the display device, which include elements that enable the user to set one or more communications protocols.

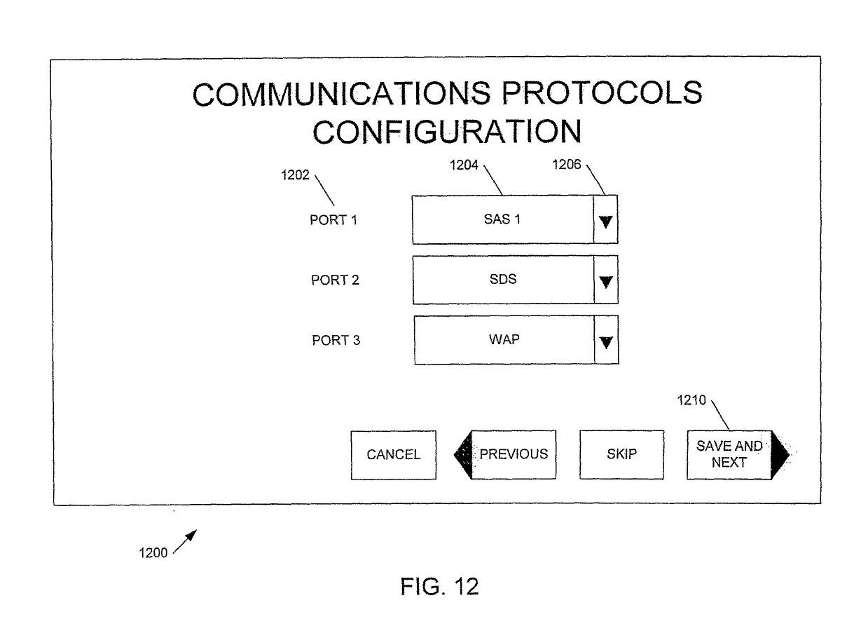

FIG. 12 illustrates an example of a display screen 1200 having user prompts relating to setting one or more communications protocols. In an embodiment, a gaming machine may have one or more communications ports, for which different communications protocols may be specified. For example, a gaming machine may have three ports, although a machine may have more or fewer ports, as well.

In an embodiment, a port may be identified in a port identifier field 1202. An indicator 1204 of the protocol to be used for the port may be included in proximity to the port identifier field 1202. In an embodiment, indicator 1204 may be a user prompt, which enables the user to specify a protocol for each port. In an embodiment, the user may modify the protocol setting 1204 using an arrow element 1206. In an embodiment, selecting arrow element 1206 may cause a drop-down menu to be displayed of supported protocols.

The example display screen 1200 indicates that “Port 1” will communicate using an “SAS 1” protocol, “Port 2” will communicate using an “SDS” protocol, and “Port 3” will communicate using a “WAP” protocol, if those settings are committed. When the user is satisfied with the communications protocol settings, the user may select the “save and next” element 1210. When the user selects the “save and next” element 1210, the game configuration settings displayed in elements 1210 are then considered to be user-affirmed settings, in an embodiment.

One or more other display screens may relate to progressive play settings. Thus, referring again to FIG. 5, in block 522, the method may cause one or more user prompts to be displayed on the display device, which include elements that enable the user to set one or more progressive play settings.

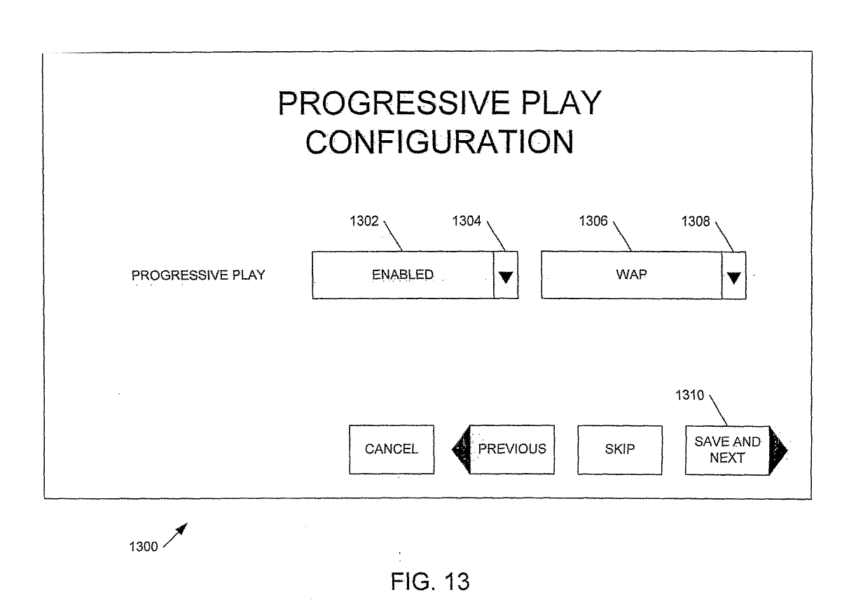

FIG. 13 illustrates an example of a display screen 1300 having user prompts relating to setting one or more progressive play settings. In an embodiment, display screen 1300 may include an indicator 1302 of whether progressive play is enabled or disabled. Further, display screen 1300 may include an indicator 1304 of a selected communications protocol for progressive play. In an embodiment, indicators 1302, 1304 may be user prompts, which enable the user to toggle between an enabled setting and a disabled setting for progressive play, and to specify a communications protocol. In an embodiment, the user may modify the settings 1302, 1304 using arrow elements 1306, 1308.

The example display screen 1300 indicates that progressive play is enabled, and that the communications protocol specified for implementing the progressive play is “WAP,” if those settings are committed. When the user is satisfied with the progressive play settings, the user may select the “save and next” element 1310. When the user selects the “save and next” element 1310, the progressive play settings displayed in elements 1310 are then considered to be user-affirmed settings, in an embodiment.

One or more other display screens may relate to output volume settings. Thus, referring again to FIG. 5, in block 524, the method may cause one or more user prompts to be displayed on the display device, which include elements that enable the user to set one or more volume settings.

FIG. 14 illustrates an example of a display screen 1400 having user prompts relating to setting one or more output volumes. In an embodiment, display screen 1400 may include multiple volume indicators 1402, 1404 for multiple sound-producing devices associated with the machine. For example, a first volume indicator 1402 may indicate a volume setting for a speaker, and a second volume indicator 1404 may indicate a volume setting for a bell. In an embodiment; indicators 1402, 1404 may be user prompts, which enable the user to raise and lower the volume settings. In an embodiment, the user may modify the settings 1402, 1404 by using arrow elements 1406, 1408.

In an embodiment, a volume setting display screen may be a last configuration setting screen in a sequence of screens. Alternatively, a volume setting display screen may occur earlier in the sequence, and some other display screen may be a last configuration setting screen in the sequence.

A last configuration setting screen in the configuration sequence may include an element that enables a user to indicate that the user desires to commit to the configuration database all user-affirmed settings, which have accumulated in temporary storage as the user proceeded through the configuration sequence. For example a selectable “save and finish” element (e.g., element 1410, FIG. 14) or the like may be provided on the last configuration setting screen. When the user is satisfied with the settings on the last configuration setting screen, the user may select the “save and finish” element.

Referring again to FIG. 5, in block 526, a determination is made whether the user has indicated that the user wishes to commit the user-affirmed settings. If so, then in block 528, a determination is made whether all user-affirmed settings are valid. A user-affirmed setting is considered to be valid when the setting has a non-null value, and the value will is not known to cause the machine to function improperly during game play. In addition, this determination may include determining whether user-affirmed settings for all primary configurable items and/or all configurable items have been specified.

If one or more user-affirmed settings are not valid, then the method prompts the user for modified settings, in block 530. This may include displaying various error messages, and providing additional user prompts, which enable the user to correct the errors (e.g., modify or specify settings). For example, but not by way of limitation, if a user has affirmed settings for related configurable items, which may cause the machine to malfunction during play, to perform an illegal action, or not to function at all, then the user may be provided notice of the improper settings, and given an opportunity to modify the user-affirmed settings.

Once all user-affirmed settings are validated, then the settings may be committed to (i.e., stored within) the configuration database, in block 532. In alternate embodiments, sets of user-affirmed settings may be committed to the configuration database at earlier times in the process. For example, each time the user presses a “save and next” element (e.g., element 630, FIG. 6), the user-affirmed settings included on the corresponding display screen may be committed at that time to the database.

In block 534 the process may cause a display screen, which indicates a successful configuration setup process, to be displayed on the display device.

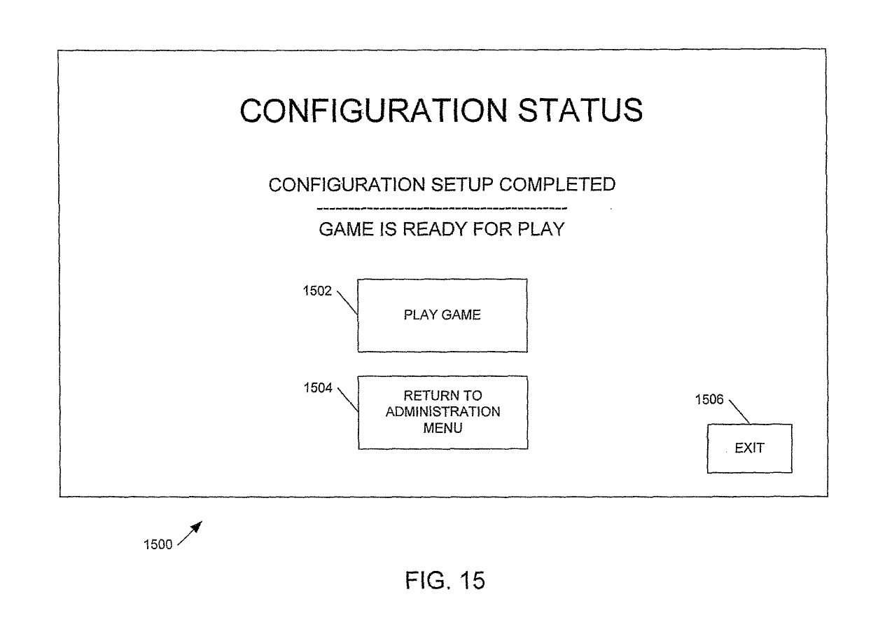

FIG. 15 illustrates an example of a display screen 1500 indicating successful configuration setup. In an embodiment, the display screen 1500 includes a first selectable element 1502, which enables the user to play the casino game. Further, in an embodiment, the display screen 1500 includes a second selectable element 1504, which enables the user to return to the administration menu (e.g., display screen 400, FIG. 4). A user may alternatively indicate that the user wishes to exit the process, for example, by selecting an “Exit” element 1506. Referring again to FIG. 5, after block 534, if the user indicates that the user would like to end the process, then the method ends.

The sequence of processing blocks in FIG. 5 may be modified, in various embodiments, without departing from the scope of the inventive subject matter. Accordingly, the sequence of displaying at least some of the user prompts may not be order dependent. For example, but not by way of limitation, causing volume user prompts to be displayed, which is shown as block 524, may be performed earlier than some or all of the previous processing blocks of FIG. 5. This may be true of the sequence of other processing blocks and user prompts, as well.

However, a subset of configurable items may have a relationship to each other, and thus may be considered “related configurable items.” Further, some related configurable item subsets may have a desired order-dependency to establishing settings for those items. In other words, it may be beneficial for a configuration tool to present user prompts for a set of related configurable items in a particular sequence.

In various embodiments, a configuration tool may cause user prompts for a set of related configurable items to be displayed in a sequence that takes into account a desired order-dependency. Several examples of related configurable item sets, and a desired order-dependency within a configuration process, are included in the next few paragraphs. It is to be understood that other sets of related configurable item sets may be relevant to a particular machine.

A first set of related configurable items includes 1) base denominations and percentages; and 2) limits. In an embodiment, a configuration tool first causes one or more first user prompts to be displayed, which enable the user to enter and/or affirm one or more base denominations and percentages (e.g., block 420, FIG. 4). Later in the configuration sequence, the configuration tool then causes one or more second user prompts to be displayed, which enable the user to enter and/or affirm one or more limits (e.g., block 422, FIG. 4).

A second set of related configurable items includes 1) limits and percentages; and 2) communications protocols. In an embodiment, a configuration tool first causes one or more first user prompts to be displayed, which enable the user to enter and/or affirm one or more base limits and percentages (e.g., blocks 420, 422, FIG. 4). Later in the configuration sequence, the configuration tool then causes one or more second user prompts to be displayed, which enable the user to enter and/or affirm one or more communications protocols (e.g., block 426, FIG. 4).

A third set of related configurable items includes 1) peripheral device existence; 2) peripheral device settings; and 3) peripheral device limits. In an embodiment, a configuration tool first determines which peripheral devices are present on a machine (e.g., block 304, FIG. 3). The configuration tool then causes one or more first user prompts to be displayed, which enable the user to enter and/or affirm one or more settings regarding whether or not a peripheral device is enabled or disabled (e.g., block 406, FIG. 4). Later in the configuration sequence, the configuration tool then causes one or more second user prompts to be displayed, which enable the user to enter and/or affirm specific configuration values for each detected and enabled device (e.g., block 410, FIG. 4). Again, later in the configuration sequence, the configuration tool then causes one or more third user prompts to be displayed, which enable the user to enter and/or affirm limits associated with the detected and enabled devices.

The various procedures described herein may be implemented in software. A software implementation can use microcode, assembly language code, or a higher-level language code. The code may be stored on one or more volatile or non-volatile computer-readable media during execution or at other times. These computer-readable media may include hard disks, removable magnetic disks, removable game cartridges, removable optical disks, magnetic cassettes, flash memory cards, digital video disks, Bernoulli cartridges, RAMs, ROMs, and the like.

In the description of the embodiments, above, reference is made to the accompanying drawings, which form a part hereof and show, by way of illustration, specific embodiments in which the inventive subject matter may be practiced. These embodiments are described in sufficient detail to enable those skilled in the art to practice the inventive subject matter, and it is to be understood that other embodiments may be utilized, and that process or mechanical changes may be made, without departing from the scope of the inventive subject matter. It will be recognized that the methods of the various embodiments can be combined in practice, either concurrently or in succession. Various permutations and combinations will be readily apparent to those skilled in the art.

Various embodiments of a method and apparatus for configuring a gaming machine have been described. Modifications that would be apparent to those of skill in the art can be made to the various embodiments to achieve the same results. In particular, but not by way of limitation, the arrangements and interconnections between various, illustrated functional blocks and method steps can be different, and other and different functional blocks and steps can be used to achieve the same function, in substantially the same way, to achieve substantially the same result. Further, the type of system within which the embodiments are incorporated can be different (e.g., it can include more, fewer or different components than those illustrated and described, or the components can be interconnected in different ways).

Although specific embodiments have been illustrated and described herein, it will be appreciated by those of ordinary skill in the art that any arrangement that is calculated to achieve the same purpose may be substituted for the specific embodiments shown. Many adaptations of the inventive subject matter described herein will be apparent to those of ordinary skill in the art. Accordingly, this application is intended to cover any adaptations or variations of the inventive subject matter. It is manifestly intended that the inventive subject matter be limited only by the following claims and equivalents thereof.

What is claimed is:

1. A method of configuring a gaming machine, the method comprising:
causing a sequence of user prompts to be displayed on a display device to enable a user to configure a set of configurable items for the gaming machine, wherein selected ones of the user prompts identify a configurable item and indicate a setting for the configurable item, and wherein items within at least one subset of configurable items have a relationship to each other, and wherein the sequence of the user prompts is at least partially defined by the relationship.

2. The method of claim 1, further comprising:
analyzing the gaming machine; and
determining the sequence of user prompts based on the analysis.

3. The method of claim 2, wherein analyzing the gaming machine comprises:
determining peripheral devices connected to the gaming machine.

4. The method of claim 2, wherein analyzing the gaming machine comprises:
reviewing data in a configuration database.

5. The method of claim 1, wherein causing the sequence of user prompts to be displayed comprises:
causing user prompts for a subset of related configurable items to be displayed in a sequence that takes into account a desired order-dependency for the subset of related configurable items.

6. The method of claim 1, wherein causing the sequence of user prompts to be displayed comprises:
causing one or more first user prompts associated with one or more base denominations for the gaming machine to be displayed; and
subsequently causing one or more second user prompts associated with one or more limits for the gaming machine to be displayed.

7. The method of claim 1, wherein causing the sequence of user prompts to be displayed comprises:
causing one or more first user prompts associated with one or more limits for the gaming machine to be displayed; and
subsequently causing one or more second user prompts associated with one or more communications protocols for the gaming machine to be displayed.

8. The method of claim 1, wherein the set of configurable items is selected from a group of items that includes a peripheral device parameter, a time, a date, a base denomination, a limit, a percentage, a game configuration parameter, a communications protocol, a progressive play parameter, a display feature, and an output volume.

9. The method of claim 1, further comprising:
receiving, from a user interface, an indicator that the user has affirmed the setting; and
storing the setting in a configuration database.

10. The method of claim 1, further comprising:
detecting a startup event; and
executing a configuration tool, which causes the multiple user prompts to be displayed.

11. The method of claim 10, wherein detecting the startup event includes detecting that a user has pressed a button within a cabinet of the machine.

12. The method of claim 10, wherein detecting the startup event includes detecting that the gaming machine has entered a boot up process.

13. The method of claim 1, wherein causing the multiple user prompts to be displayed comprises:
causing one or more identities of one or more peripheral devices connected to the gaming machine to be displayed;
indicating a current setting of each of the one or more peripheral devices as being in an enabled state or a disabled state; and
wherein the method further comprises modifying the setting of the one or more peripheral devices in response to information received from a user interface.

14. The method of claim 1, further comprising:
receiving information, through a first user interface, which indicates that the user wants to perform a test of a peripheral device connected to the gaming machine; and
performing the test of the peripheral device.

15. The method of claim 14, wherein performing the test comprises performing a test selected from a group of tests that includes printing a test ticket by a printer peripheral device, ejecting coins by a hopper peripheral device, detecting a touch screen input, validating a coin inserted into a coin validator peripheral device, validating a bill inserted into a bill validator peripheral device, sending a ping data message over a network, testing a serial communications port, and providing an output signal to an audio output device.

16. The method of claim 14, wherein performing the test comprises performing a test selected from a group of tests that includes detecting a door open state and a door closed state, detecting a switch state change, and turning a lamp on and off.

17. A method comprising:
causing a first display screen in a series of display screens to be displayed on a display device associated with a gaming machine, wherein the first display screen includes one or more first configuration-related user prompts related to one or more first configurable items, and wherein selected ones of the one or more configuration-related user prompts include a configurable item identifier and a displayed setting;
receiving a first indication, from a user interface, that a user desires to continue a configuration process of the gaming machine;
in response to receiving the first indication, causing a second display screen in a series of display screens to be displayed on a display device associated with a gaming machine, wherein the second display screen includes one or more second configuration-related user prompts related to one or more second configurable items.

18. The method of claim 17, further comprising:
in response to receiving the first indication, classifying the displayed setting as a user-affirmed setting.

19. The method of claim 17, further comprising:
receiving a second indication that the user desires to commit the displayed setting to a configuration database; and
in response to receiving the second indication, storing information representative of the displayed setting in the configuration database.

20. A method comprising:
determining one or more identities of one or more peripheral devices connected to a gaming machine; and
causing one or more user prompts to be displayed on a display device to enable a user to configure the one or more peripheral devices.

21. The method of claim 20, wherein determining the one or more identities comprises detecting the one or more peripheral devices.

22. The method of claim 20, wherein causing the one or more user prompts to be displayed comprises:
causing a first set of user prompts to be displayed to enable the user to configure device parameters; and
subsequently causing a second set of user prompts to be displayed to enable the user to configure device limits.

23. A computer-readable medium having program instructions stored thereon to perform a method, which when executed within an apparatus, result in:
causing a sequence of user prompts to be displayed on a display device to enable a user to configure a set of configurable items for the gaming machine, wherein selected ones of the user prompts identify a configurable item and indicate a setting for the configurable item, and wherein items within at least one subset of configurable items have a relationship to each other, and wherein the sequence of the user prompts is at least partially defined by the relationship.

24. The computer-readable medium of claim 23, wherein executing the program instructions further results in:
analyzing the gaming machine; and
determining the sequence of user prompts based on the analysis.

25. The computer-readable medium of claim 23, wherein executing the program instructions further results in causing user prompts for a subset of related configurable items to be displayed in a sequence that takes into account a desired order-dependency for the subset of related configurable items.

26. An electronic gaming machine comprising:
at least one processor, to cause a sequence of user prompts to be displayed on a display device in order to enable a user to configure a set of configurable items for the electronic gaming machine, wherein selected ones of the user prompts identify a configurable item and indicate a setting for the configurable item, and wherein items within at least one subset of configurable items have a relationship to each other, and wherein the sequence of the user prompts is at least partially defined by the relationship.

27. The electronic gaming machine of claim 26, further comprising:
the display device, which includes a touch-screen that serves as a user interface for entering and affirming settings for configurable items.

28. The electronic gaming machine of claim 26, further comprising:
one or more communications ports, wherein the at least one processor causes one or more user prompts to be displayed in order to enable the user to configure communications protocols for the one or more communications ports.
